(19) United States
(12) Patent Application Publication
(10) Pub. No.: US 2017/0167729 A1
(43) Pub. Date: Jun. 15, 2017

(54) MULTIPLE FEED PLATEFINS WITHIN A HOT GAS PATH COOLING SYSTEM IN A COMBUSTOR BASKET IN A COMBUSTION TURBINE ENGINE

(71) Applicant: Siemens Aktiengesellschaft, München (DE)

(72) Inventors: Richard L. Thackway, Oviedo, FL (US); Charalambos Polyzopoulos, Orlando, FL (US)

(73) Assignee: Siemens Aktiengesellschaft, Munchen (DE)

(21) Appl. No.: 15/325,672

(22) PCT Filed: Jul. 30, 2014
(86) PCT No.: PCT/US2014/048795

§ 371 Date: Jan. 11, 2017

(51) Int. Cl. F23R 3/00; F02C 7/18; F23R 3/06

(52) U.S. Cl. CPC F23R 3/005; F23R 3/06; F02C 7/18

(57) ABSTRACT

A hot gas path cooling system (10) for a combustor of a gas turbine engine, whereby the cooling system (10) is positioned within a combustor basket (18) is disclosed. The cooling system (10) may include a platefin cooling system (24) formed from a platefin member (26) positioned radially inward from an outer wall (28) forming a combustor basket (18). At least first and second cooling circuits (34, 36) may be formed between the platefin member (26) and the combustor basket (18) and may be separated from each other by a first rib section (38). The second cooling circuit (36), thus, may be positioned downstream from the first cooling circuit (34) and may receive fresh cooling fluid through one or more inlets (52), not from the first cooling circuit (34). As such, the downstream second cooling circuit (36) may be cooled similarly to the first cooling circuit (34).

### FIELD OF THE INVENTION

The present invention relates in general to cooling systems and, more particularly, to a cooling system for a combustor downstream from a combustor basket in a combustion turbine engine.

### BACKGROUND OF THE INVENTION

Traditionally, platefins are used within combustor baskets to provide a cooling mechanism for the walls forming the combustor basket by keeping component temperatures low, thereby preventing premature failure of the combustor basket before scheduled maintenance. Traditional platefins are fed with shell air at an upstream end of the platefin. As the air flows through the fins, it heats becoming less and less effective at cooling. In addition, the leading edge of the platefin experiences some film cooling from the exiting air from the upstream platefin, but this benefit only lasts for a finite distance as the air is exposed to the hot gases, which causes the air to heat up. This increase in temperature of the cooling air contributes to a higher part temperature in the downstream section of the platefin which limits the physical length and operational life of the platefin.

### SUMMARY OF THE INVENTION

Set forth below is a brief summary of the invention that solves the foregoing problems and provides benefits and advantages in accordance with the purposes of the present invention as embodied and broadly described herein. A hot gas path cooling system for a combustor of a gas turbine engine, whereby the cooling system is positioned in a combustor basket is disclosed. The cooling system may include a platefin cooling system formed from a platefin member positioned radially inward from an outer wall forming a combustor basket. At least first and second cooling circuits may be formed between the platefin member and the combustor basket and may be separated from each other by a first rib section. The second cooling circuit, thus, may be positioned downstream from the first cooling circuit and may receive fresh cooling fluid through one or more inlets, not from the first cooling circuit. As such, the downstream second cooling circuit may be cooled similarly to the first cooling circuit.

In at least one embodiment, the hot gas path cooling system for a combustor of a gas turbine engine may include a combustor basket formed from at least one outer wall defining a combustor chamber. The hot gas path cooling system may include one or more platefin cooling systems formed from a platefin member positioned radially inward from an inner surface of the outer wall forming the combustor basket. One or more first rib sections may extend between the platefin member and the combustor basket, thereby separating a first cooling circuit from a second cooling circuit, whereby the first cooling circuit is upstream from the second cooling circuit. The cooling circuit may include one or more first exhaust outlets positioned in the platefin member upstream from the first rib section. The second cooling circuit may include one or more second exhaust outlets positioned downstream from the first rib section.

The platefin cooling system may include one or more first cooling circuit inlets positioned upstream from the first exhaust outlet. The first cooling circuit inlet may extend radially outward through the inner surface of the outer wall defining a least a portion of the first cooling circuit. The first cooling circuit inlet may be formed from a plurality of orifices positioned circumferentially about the outer wall of the combustor basket. In at least one embodiment, the first cooling circuit inlet may be formed from a plurality of orifices positioned circumferentially about the outer wall of the combustor basket. The platefin cooling system may also include a second cooling circuit inlet positioned upstream from the second exhaust outlet in the second cooling circuit. The second cooling circuit inlet may extend radially outward through the inner surface of the outer wall defining a least a portion of the second cooling circuit. The second cooling circuit inlet may be formed from a plurality of orifices positioned circumferentially about the outer wall of the combustor basket. In at least one embodiment, the platefin member may be generally cylindrical.

In at least one embodiment, a radially extending opening of the first cooling circuit may be equal to a radially extending opening of the second cooling circuit. The first exhaust outlet of the first cooling circuit may be positioned immediately upstream from the first rib section and within a distance of the first rib section that is less than a diameter of the first exhaust outlet. A combustor cooling system may have one or more combustor cooling system outlets configured to emit cooling fluid into the combustor chamber. The combustor cooling system outlet may be positioned radially inward from the platefin member.

In at least one embodiment, the hot gas path cooling system may include a plurality of cooling circuits and in particular may include three or more cooling circuits. In such embodiment, the second rib section may extend between the platefin member and the combustor basket, thereby separating the second cooling circuit from a third cooling circuit. The second cooling circuit may be upstream from the third cooling circuit. The second cooling circuit may include at least one second exhaust outlet positioned in the platefin member upstream from the second rib section. The third cooling circuit may include one or more third exhaust outlets positioned downstream from the second rib section. A third cooling circuit inlet may be positioned upstream from the third exhaust outlet in the third cooling circuit. The third cooling circuit inlet may extend radially outward through the inner surface of the outer wall defining a least a portion of the third cooling circuit.

During use, the combustor contains a combustion flame within the combustor basket and produces a hot gas exhaust that flows downstream from the combustor basket into the transition. Cooling air flows into the hot gas path cooling system to cool aspects of the combustor basket and the transition to prolong the life of the components forming the combustor basket and the transition. The cooling air may be supplied by one or more sources, including, but not limited to, compressed air, such as from the compressor, compressor bleed air, or other appropriate sources. The cooling air may be supplied to the platefin cooling system where the cooling fluids enter the first cooling circuit via the one or more first cooling circuit inlets. The cooling air pulls heat from the platefin member and increases in temperature. The cooling air is discharged from the platefin cooling system via the one or more first exhaust outlets after flowing through a portion of the platefin cooling system. Simultaneously, cooling air may flow into the second cooling circuit via the one or more second cooling circuit inlets. The cooling air pulls heat from the platefin member and increases in temperature. The cooling air is discharged from the platefin cooling system via the one or more second exhaust outlets after flowing through a portion of the platefin cooling system downstream from the first cooling circuit. By dividing the platefin cooling system into multiple cooling circuits, fresh cooling air is able to be supplied to downstream aspects of the platefin cooling system to provide enhanced cooling to those regions in comparison to single chamber cooling systems. Cooling air may also flow into the combustor cooling system and be emitted from the one or more combustor cooling system outlets. The cooling air flowing from the combustor cooling system outlets may cool the surfaces of the platefin member and the transition housing that are exposed to the hot gas path.

An advantage of the platefin cooling system is that the platefin cooling system maintains a more consistent temperature gradient across its length extending downstream in comparison to conventional single entry point systems.

Another advantage of the platefin cooling system is that the platefin cooling system is configured such that once cooling air has been heated to a design temperature, the cooling air is exhausted from the system and fresh cooling air is used to cool aspects of the platefin cooling system downstream thereof. The cooling air exhausted, even though heated, is still cooler than the combustion gases and provides come film cooling for the downstream section, unlike what is found in a conventional single feed system wherein the downstream section does not receive any film cooling air that hasn't been heated beyond an effective temperature.

These and other advantages and objects will become apparent upon review of the detailed description of the invention set forth below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is cross-sectional side view of a turbine engine including the hot gas path cooling system.

FIG. 2 is a detailed, cross-sectional side view of a combustor within the turbine engine of FIG. 1 together with the hot gas path cooling system taken at detail line 2-2 in FIG. 1.

FIG. 3 is a partial cross-sectional view detailed, cross-sectional side view of the hot gas path cooling system including the platefin cooling system and the combustor cooling system taken at detail line 3-3 in FIG. 2.

FIG. 4 is a graph of the temperature of a platefin member with the platefin cooling system compared to a platefin member with only a single cooling circuit.

FIG. 5 is a partial, cross-sectional, perspective view of the platefin cooling system taken at section line 5-5 in FIG. 2.

FIG. 6 is an end view facing upstream of the platefin cooling system at section line 6-6 in FIG. 2.

FIG. 7 is a partial cross-sectional view detailed, cross-sectional side view of an alternative embodiment of the hot gas path cooling system including the platefin cooling system and the combustor cooling system taken at detail line 7-7 in FIG. 2.

### DETAILED DESCRIPTION OF THE INVENTION

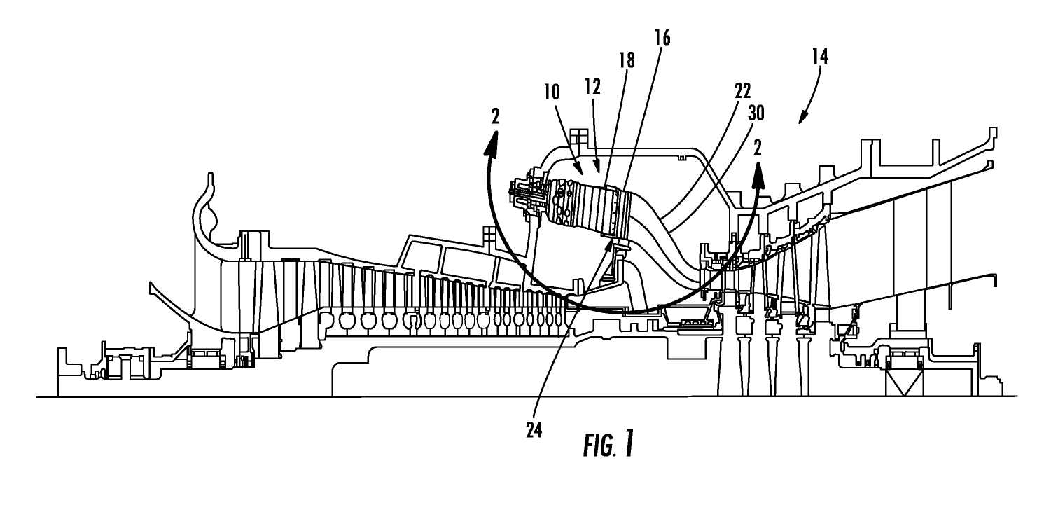

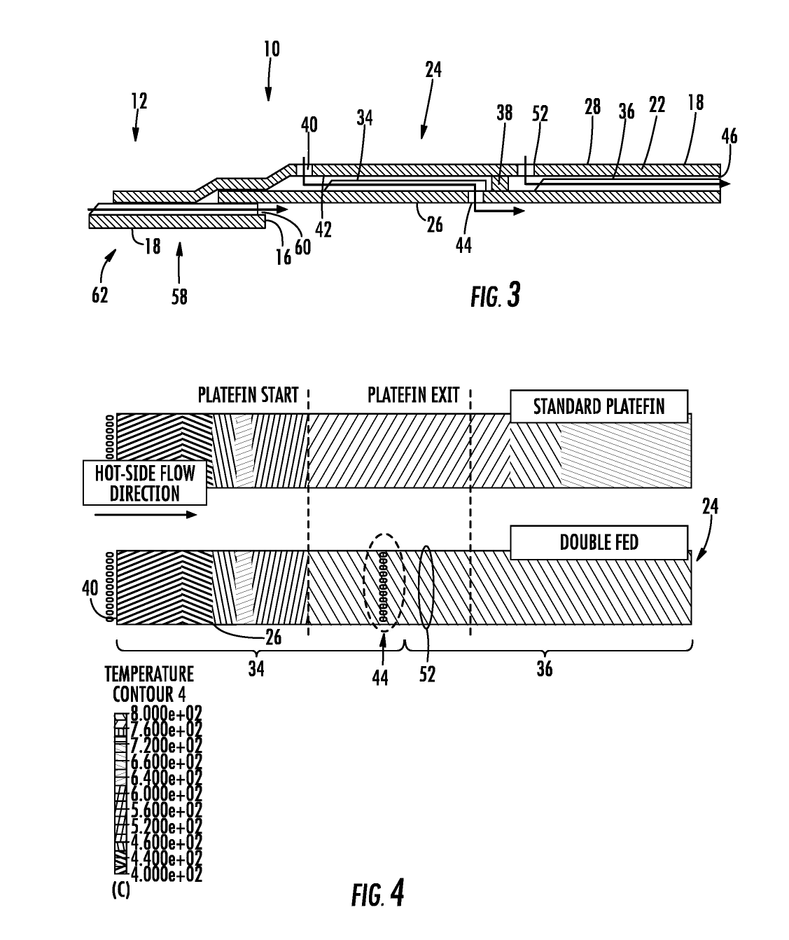

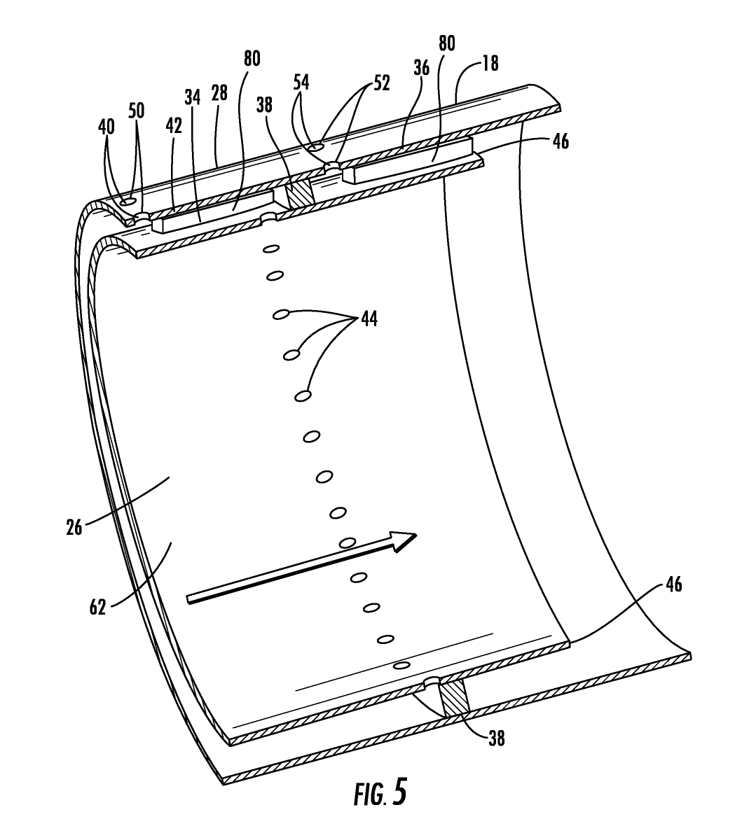

As shown in FIGS. 1-7, a hot gas path cooling system 10 for a combustor 12 of a gas turbine engine 14, whereby the cooling system 10 is positioned within a combustor basket 18 is disclosed. The cooling system 10 may include a platefin cooling system 24 formed from a platefin member 26, as shown in FIGS. 3, 5 and 6, positioned radially inward from an outer wall 28 forming a combustor basket 18. At least first and second cooling circuits 34, 36 may be formed between the platefin member 26 and the combustor basket 18 and may be separated from each other by a first rib section 38. The second cooling circuit 36, thus, may be positioned downstream from the first cooling circuit 34 and may receive fresh cooling fluid through one or more inlets 40, not from the first cooling circuit 34. As such, the downstream second cooling circuit 36 may be cooled similarly to the first cooling circuit 34.

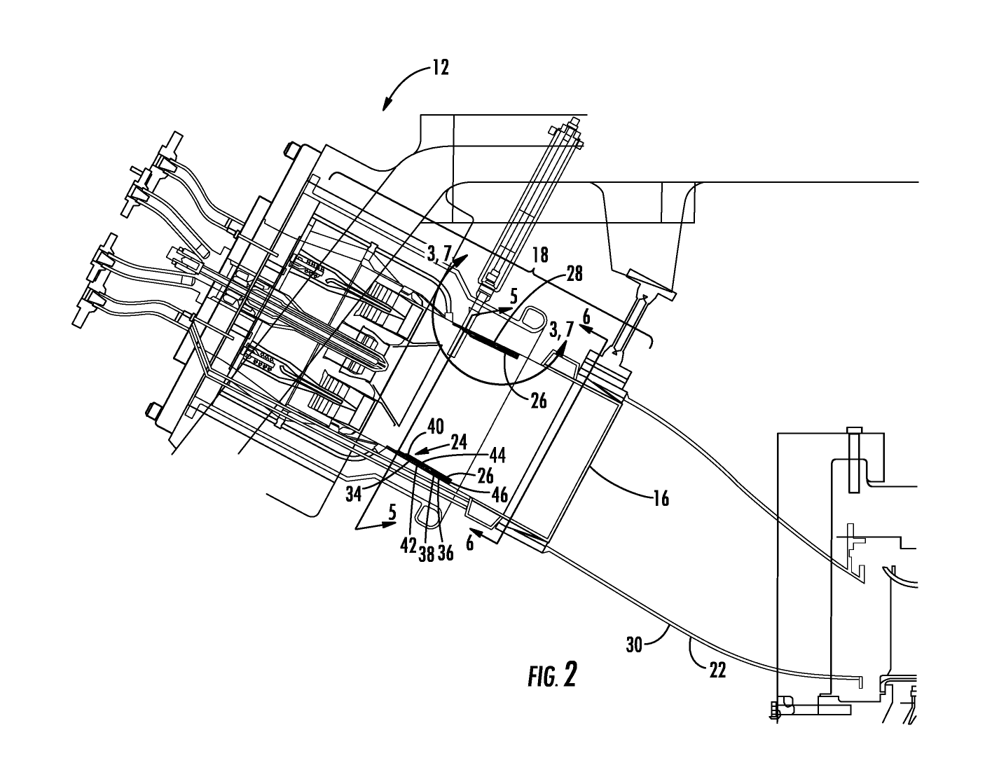

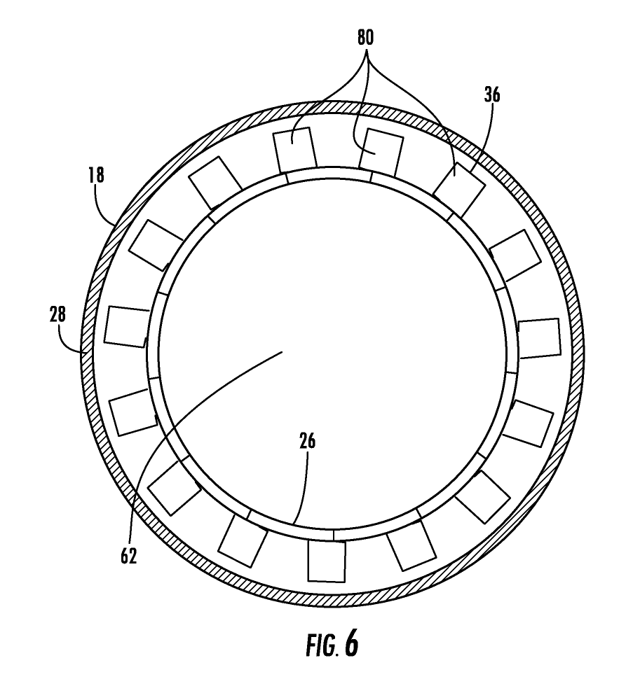

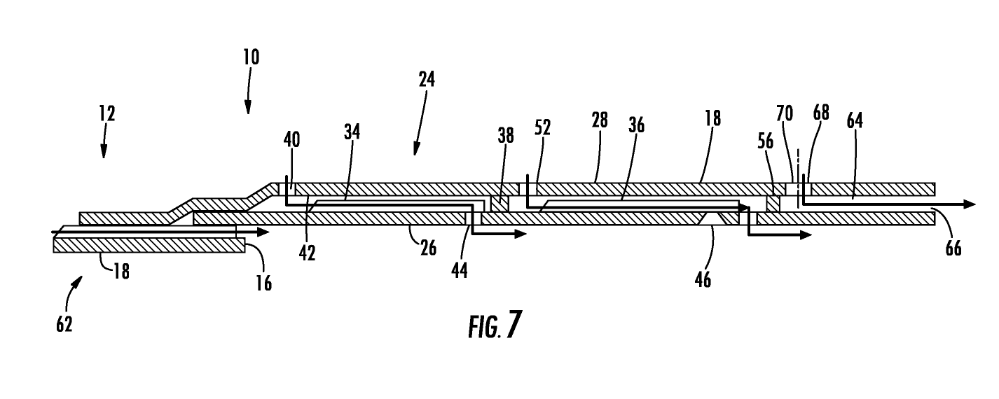

In at least one embodiment, the hot gas path cooling system 10 may be configured to cool aspects of a combustor 12, such as, but not limited to, a transition housing 30 or portions of a combustor basket 18, or both. As shown in FIG. 2, the transition housing 30 form a transition 22 extending downstream from a downstream end 16 of a combustor basket 18. The transition housing 30 may be formed from one or more outer walls 28. In at least one embodiment, the transition housing 30 may be cylindrical as shown in FIGS. 5 and 6, and in other embodiments, may have other shapes. The transition housing 30 may be formed from any appropriate material capable of withstanding the heat found within the hot gases in the hot gas path defined by the combustor basket 18 and the transition housing 30.

The combustor basket 18 may be formed from one or more outer walls 28. In at least one embodiment, the combustor basket 18 may be cylindrical as shown in FIGS. 5 and 6, and in other embodiments, may have other shapes. The combustor basket 18 may be formed from any appropriate material capable of withstanding the heat found within the hot gases in the hot gas path defined by the combustor basket 18 and the transition housing 30.

As shown in FIG. 3, one or more platefin cooling systems 24 may be formed from a platefin member 26 positioned radially inward from an inner surface 42 of the one or more outer walls 28 forming the combustor basket 18. The platefin member 26 may be configured to have a shape that maintains a consistent radial thickness of the cooling circuits, such as, but not limited to, the first and second cooling circuits 34, 36. In other words, a radially extending opening of the first cooling circuit 34 may be equal to a radially extending opening of the second cooling circuit 36. As such, in at least one embodiment, the platefin member 26 may be shaped substantially similar to the combustor basket 18. Thus, in embodiments where the combustor basket 18 is generally cylindrical, the platefin member 26 may be generally cylindrical as well, as shown in FIGS. 5 and 6. In other embodiment, a radial thickness of the cooling circuits, such as, but not limited to, one of the first and second cooling circuits 34, 36, or both may vary. Furthermore, the platefin member 26 may have a different configuration than the combustor basket 18. The platefin member 26 may be formed from any appropriate material capable of withstanding the heat found within the hot gases in the hot gas path defined by the combustor basket 18 and the combustor basket 18. As shown in FIGS. 5 and 6, one or more fins 80 may extend radially outward from the platefin member 26. The fins 80 may have any appropriate shape. The fins 80 may be positioned circumferentially between exhaust outlets 44 positioned in the platefin member 26 so as to not block the exhaust outlets 44. The fins 80 enhance the efficiency of the hot gas path cooling system 10.

In at least one embodiment, the first and second cooling circuits 34, 36 may be separated by one or more first rib sections 38 extending between the platefin member 26 and the combustor basket 18. The first rib section 38 may have any appropriate thickness, width and length. In at least one embodiment, the first rib sections 38 may be positioned halfway along a length of the platefin member 26. In other embodiments, the first rib section 38 may be positioned in other positions along the length of the platefin member 26. The first cooling circuit 34 may be positioned upstream from the second cooling circuit 36. The first cooling circuit 34 may be equal in size to the second cooling circuit 36 or may be differently sized. The first cooling circuit 34 may include one or more first exhaust outlets 44 positioned in the platefin member 26 upstream from the first rib section 38. The second cooling circuit 36 may include one or more second exhaust outlets 46 positioned downstream from the first rib section 38. A first cooling circuit inlet 40 may be positioned upstream from the first exhaust outlet 44. The first cooling circuit inlet 40 may extend radially outward through the inner surface 42 of the outer wall 28 defining a least a portion of the first cooling circuit 34. The first cooling circuit inlet 40 may be formed from a plurality of orifices 50 positioned circumferentially about the outer wall 28 of the combustor basket 18. In at least one embodiment, the first cooling circuit inlet 40 may be formed from a plurality of slots, a continuous, circumferentially extending slot or orifice or other configuration.

One or more second cooling circuit inlets 52 may be positioned upstream from the second exhaust outlet 46 in the second cooling circuit 36. The second cooling circuit inlet 52 may extend radially outward through the inner surface 42 of the outer wall 28 defining a least a portion of the second cooling circuit 36. The second cooling circuit inlet 52 may be formed from a plurality of orifices 54 positioned circumferentially about the outer wall 28 of the combustor basket 18. The second cooling circuit inlet 52 may be formed from a plurality of orifices 54 positioned circumferentially about the outer wall 28 of the combustor basket 18. In at least one embodiment, the second cooling circuit inlet 52 may be formed from a plurality of slots, a continuous, circumferentially extending slot or orifice or other configuration.

In at least one embodiment, the first exhaust outlet 44 of the first cooling circuit 34 may be positioned immediately upstream from the first rib section 38. The first exhaust outlet 44 of the first cooling circuit 34 may be positioned within a distance of the first rib section 38 that is less than a diameter of the first exhaust outlet 44. In other embodiments, the first exhaust outlet 44 of the first cooling circuit 34 may be positioned further upstream from the first rib section 38 or may be positioned closer to the first rib section 38. Similarly, the second exhaust outlet 46 of the second cooling circuit 36 may be positioned immediately upstream from a second rib section 56 or may be positioned at a downstream end of the platefin member 26. In embodiments including the second rib section 56, the second exhaust outlet 46 of the second cooling circuit 36 may be positioned within a distance of the second rib section 56 that is less than a diameter of the second exhaust outlet 46. In other embodiments, the second exhaust outlet 46 of the second cooling circuit 36 may be positioned further upstream from the second rib section 56 or may be positioned closer to the second rib section 56.

The hot gas path cooling system 10 may also include a combustor cooling system 58 having one or more combustor cooling system outlets 60 configured to introduce cooling fluid into a combustor chamber 62 defined, at least in part, by the combustor basket 18 and the platefin member 26. The combustor cooling system outlet 60 may be formed from one or more orifices, slots or other appropriate components. In at least one embodiment, the combustor cooling system outlet 60 may be generally cylindrical as shown in FIGS. 5 and 6. One or more of the combustor cooling system outlets 60 may be positioned components forming the combustor basket 18. In at least one embodiment, the transition 22 may be positioned radially outward from the downstream end 16 of the combustor basket 18. The combustor cooling system outlet 60 may be positioned radially inward from the platefin member 26.

In at least one embodiment, the hot gas path cooling system 10 may include a plurality of cooling circuits and in particular may include three or more cooling circuits. For example, as shown in FIG. 7, the hot gas path cooling system 10 may include a third cooling circuit 64 positioned downstream from the second cooling circuit 36. The second rib section 56 may extend between the platefin member 26 and the combustor basket 18, thereby separating the second cooling circuit 36 from the third cooling circuit 64. The second cooling circuit 36 may be upstream from the third cooling circuit 64, and the second cooling circuit 36 may include one or more second exhaust outlets 46 positioned in the platefin member 26 upstream from the second rib section 56. The third cooling circuit 64 may include one or more third exhaust outlets 66 positioned downstream from the second rib section 56. A third cooling circuit inlet 68 may be positioned upstream from the third exhaust outlet 66 in the third cooling circuit 64. The third cooling circuit inlet 68 may extend radially outward through the inner surface 42 of the outer wall 28 defining a least a portion of the third cooling circuit 64. The first cooling circuit inlet 68 may be formed from a plurality of orifices 70 positioned circumferentially about the outer wall 28 of the combustor basket 18. The components forming the third cooling circuit inlet 68 may include the other aspects of the first and second cooling circuits 34, 36 described above.

During use, the combustor 12 contains a combustion flame within the combustor basket 18 and produces a hot gas exhaust that flows downstream from the combustor basket 18 into the transition 22. Cooling air flows into the hot gas path cooling system 10 to cool aspects of the combustor basket 18 and the transition 22 to prolong the life of the components forming the combustor basket 18 and the transition 22. The cooling air may be supplied by one or more sources, including, but not limited to, compressed air, such as from the compressor, compressor bleed air, or other appropriate sources. The cooling air may be supplied to the platefin cooling system 24 where the cooling fluids enter the first cooling circuit 34 via the one or more first cooling circuit inlets 40. The cooling air pulls heat from the platefin member 26 and increases in temperature. The cooling air is discharged from the platefin cooling system 24 via the one or more first exhaust outlets 44 after flowing through a portion of the platefin cooling system 24. Simultaneously, cooling air may flow into the second cooling circuit 36 via the one or more second cooling circuit inlets 52. The cooling air pulls heat from the platefin member 26 and increases in temperature. The cooling air is discharged from the platefin cooling system 24 via the one or more second exhaust outlets 46 after flowing through a portion of the platefin cooling system 24 downstream from the first cooling circuit 34. By dividing the platefin cooling system 24 into multiple cooling circuits, fresh cooling air is able to be supplied to downstream aspects of the platefin cooling system 24 to provide enhanced cooling to those regions in comparison to single chamber cooling systems. Cooling air may also flow into the combustor cooling system 58 and be emitted from the one or more combustor cooling system outlets 60. The cooling air flowing from the combustor cooling system outlets 60 may cool the surfaces of the platefin member 26 and the combustor basket 18 that are exposed to the hot gas path.

The foregoing is provided for purposes of illustrating, explaining, and describing embodiments of this invention. Modifications and adaptations to these embodiments will be apparent to those skilled in the art and may be made without departing from the scope or spirit of this invention or the following claims.

1-15. (canceled)

16. A hot gas path cooling system for a combustor of a gas turbine engine, comprising:
a combustor basket formed from at least one outer wall defining a combustor chamber;
a combustor cooling system in the combustor basket, the combustor cooling system having at least one combustor cooling system outlet;
at least one platefin cooling system formed from a platefin member positioned radially inward from an inner surface of the at least one outer wall forming the combustor basket, wherein the at least one combustor cooling system outlet is positioned radially inward from the platefin member and is configured to emit cooling fluid into the combustor chamber along a radially inner surface of platefin member;
at least one first rib section extends between the platefin member and the combustor basket, thereby separating a first cooling circuit from a second cooling circuit, wherein the first cooling circuit is upstream from the second cooling circuit;
wherein the first cooling circuit includes at least one first exhaust outlet positioned in the platefin member upstream from the at least one first rib section, wherein the at least one first exhaust outlet of the first cooling circuit is configured to extend perpendicular between a radially outer surface of platefin member and the radially inner surface of platefin member; and
wherein the second cooling circuit includes at least one second exhaust outlet positioned downstream from the at least one first rib section.

17. The hot gas path cooling system of claim 16, further comprising a first cooling circuit inlet positioned upstream from the first exhaust outlet.

18. The hot gas path cooling system of claim 17, wherein the first cooling circuit inlet extends radially outward through the inner surface of the outer wall defining a least a portion of the first cooling circuit.

19. The hot gas path cooling system of claim 17, wherein the first cooling circuit inlet is formed from a plurality of orifices positioned circumferentially about the outer wall of the combustor basket.

20. The hot gas path cooling system of claim 16, further comprising a second cooling circuit inlet positioned upstream from the at least one second exhaust outlet in the second cooling circuit.

21. The hot gas path cooling system of claim 20, wherein the second cooling circuit inlet extends radially outward through the inner surface of the outer wall defining a least a portion of the second cooling circuit.

22. The hot gas path cooling system of claim 20, wherein the second cooling circuit inlet is formed from a plurality of orifices positioned circumferentially about the outer wall of the combustor basket.

23. The hot gas path cooling system of claim 16, wherein the platefin member is generally cylindrical.

24. The hot gas path cooling system of claim 16, wherein a radially extending opening of the first cooling circuit is equal to a radially extending opening of the second cooling circuit.

25. The hot gas path cooling system of claim 16, wherein the at least one first exhaust outlet of the first cooling circuit is positioned immediately upstream from the at least one first rib section and within a distance of the at least one first rib section that is less than a diameter of the at least one first exhaust outlet.

26. The hot gas path cooling system of claim 16, wherein at least one second rib section extends between the platefin member and the combustor basket, thereby separating the second cooling circuit from a third cooling circuit, wherein the second cooling circuit is upstream from the third cooling circuit, wherein the second cooling circuit includes at least one second exhaust outlet positioned in the platefin member upstream from the at least one second rib section, and wherein the third cooling circuit includes at least one third exhaust outlet positioned downstream from the at least one second rib section.

27. The hot gas path cooling system of claim 16, further comprising a third cooling circuit inlet positioned upstream from the at least one third exhaust outlet in the third cooling circuit and wherein the third cooling circuit inlet extends radially outward through the inner surface of the outer wall defining a least a portion of the third cooling circuit.

28. The hot gas path cooling system of claim 16, wherein the third cooling circuit inlet is formed from a plurality of orifices positioned circumferentially about the outer wall of the combustor basket.

29. A hot gas path cooling system for a combustor of a gas turbine engine, comprising:
a combustor basket formed from at least one outer wall defining a combustor chamber;
a combustor cooling system in the combustor basket, the combustor cooling system having at least one combustor cooling system outlet;
at least one platefin cooling system formed from a platefin member positioned radially inward from an inner surface of the at least one outer wall forming the combustor basket, wherein the at least one combustor cooling system outlet is positioned radially inward from the platefin member and is configured to emit cooling fluid into the combustor chamber along a radially inner surface of platefin member;
at least one first rib section extends between the platefin member and the combustor basket, thereby separating a first cooling circuit from a second cooling circuit, wherein the first cooling circuit is upstream from the second cooling circuit;
wherein the first cooling circuit includes at least one first exhaust outlet positioned in the platefin member upstream from the at least one first rib section, wherein the at least one first exhaust outlet of the first cooling circuit is configured to extend perpendicular between a radially outer surface of platefin member and the radially inner surface of platefin member;
wherein the second cooling circuit includes at least one second exhaust outlet positioned downstream from the at least one first rib section;
a first cooling circuit inlet positioned upstream from the first exhaust outlet, wherein the first cooling circuit inlet extends radially outward through the inner surface of the outer wall defining a least a portion of the first cooling circuit;
a second cooling circuit inlet positioned upstream from the at least one second exhaust outlet in the second cooling circuit, wherein the second cooling circuit inlet extends radially outward through the inner surface of the outer wall defining a least a portion of the second cooling circuit.

30. The hot gas path cooling system of claim 29, wherein the first cooling circuit inlet is formed from a plurality of orifices positioned circumferentially about the outer wall of the combustor basket, and wherein the second cooling circuit inlet is formed from a plurality of orifices positioned circumferentially about the outer wall of the combustor basket.

31. The hot gas path cooling system of claim 29, wherein the at least one first exhaust outlet of the first cooling circuit is positioned immediately upstream from the at least one first rib section and within a distance of the at least one first rib section that is less than a diameter of the at least one first exhaust outlet.

32. The hot gas path cooling system of claim 29, further comprising a combustor cooling system having at least one combustor cooling system outlet configured to emit cooling fluid into the combustor chamber, wherein the at least one combustor cooling system outlet is positioned radially inward from the platefin member.

33. The hot gas path cooling system of claim 29, wherein at least one second rib section extends between the platefin member and the combustor basket, thereby separating the second cooling circuit from a third cooling circuit, wherein the second cooling circuit is upstream from the third cooling circuit, wherein the second cooling circuit includes at least one second exhaust outlet positioned in the platefin member upstream from the at least one second rib section, and wherein the third cooling circuit includes at least one third exhaust outlet positioned downstream from the at least one second rib section.
